(19) United States
(12) Patent Application Publication
(10) Pub. No.: US 2012/0171547 A1
(43) Pub. Date: Jul. 5, 2012

(54) PRINTED BATTERY USING NON-AQUEOUS ELECTROLYTE AND BATTERY PACKAGING

(75) Inventors: Thomas J. Pennaz, Champlin, MN (US); Mark Schuster, Andover, MN (US)

(73) Assignee: Thin Profile Technologies, Champlin, MN (US)

(21) Appl. No.: 13/313,438

(22) Filed: Dec. 7, 2011

Related U.S. Application Data
(60) Provisional application No. 61/420,368, filed on Dec. 7, 2010.

(51) Int. Cl. H01M 6/40

(52) U.S. Cl. 429/124

(57) ABSTRACT

The present subject matter relates generally to methods and apparatus for printed batteries using non-aqueous electrolyte and battery packaging. Various embodiments of the present subject matter include an all printed carbon and zinc battery having a lower substrate, a cathode current collector printed on the lower substrate, and a cathode printed on the cathode current collector. In various embodiments, an anode is printed on the lower substrate adjacent the cathode, a non-aqueous electrolyte is printed over the anode and the cathode, and a top substrate is laminated to the electrolyte. Other aspects and embodiments are provided herein.

### CLAIM OF PRIORITY

This application claims the benefit of priority under 35 U.S.C. §119(e) of U.S. Provisional Patent Application Ser. No. 61/420,368, entitled “PRINTED BATTERY USING NON-AQUEOUS ELECTROLYTE AND BATTERY PACKAGING”, filed on Dec. 7, 2010, which is herein incorporated by reference in its entirety.

### BACKGROUND

Thin batteries have been proposed in the prior art to meet a variety of needs. The ultra thin form factor is desirable in applications where a traditional can batteries or coin cell batteries will not fit within the desired shape. This is especially true in applications which require very thin power sources.

Thin batteries have been proposed in the prior art to meet a variety of needs. One such application includes embedding a power source into a credit card like structure which requires the battery to be very thin. Furthermore, many existing manufacturing processes require high processing temperatures or pressure which puts further demands on the battery. In credit card manufacturing, one such process is known as hot lamination which subjects the battery to both high temperature (>120 C) and high pressure (>15 Kg./cm2) to form the card.

Additional desired features include the ability to form the battery into a variety of shapes and sizes to fit the battery into the desired product. Ideally, the ability to customize the battery to a unique shape or size is accomplished at low cost and would not require an extensive level of unique tooling or other process changes which would make the battery cost prohibitive.

There exists in the art thin batteries based on a variety of battery chemistries. This includes batteries based on carbon zinc, lithium ion, lithium polymer and the like. The packaging of the batteries is typically based on barrier films which have a distinct heat seal layer to seal the perimeter of the battery. The barrier properties of the packaging films are selected based on the battery chemistry and the liquid present in the battery electrolyte. For example, if carbon zinc cells are produced, the barrier film is selected to prevent the loss of water from the electrolyte. In the case of lithium ion batteries with a non-aqueous electrolyte, the barrier film is selected to prevent loss of the non-aqueous solvent used in the electrolyte.

Batteries types can be divided into two broad categories—primary and secondary cells. Primary cells are characterized by the fixed capacity of the cells, which cannot be recharged. Secondary batteries can be recharged through an external circuit.

A variety of primary battery chemistries are known in the art. Examples of battery chemistries include carbon zinc, alkaline manganese dioxide, zinc air, nickel cadmium, silver oxide, mercuric oxide as well as a variety of lithium battery chemistries.

The basic construction of a battery consists of four primary elements anode, cathode, electrolyte and packaging. In the case of a traditional alkaline can battery, the anode material is zinc metal, the cathode is manganese dioxide, the electrolyte is an aqueous potassium hydroxide solution and the packaging is a metal can designed to meet the specified size requirements. Those skilled in the art will recognize that many variations exist regarding the formulations of the anode, cathode and electrolyte materials as well as the shape and construction of the packaging.

Battery electrolytes consist of two main components and serve the function of providing chemical compounds to the anode and cathode to realize the desired electrochemical reactions as well as provide conductivity to allow electron flow to harness the electrical energy generated by the cell. Battery electrolytes can be broadly divided into three groups—aqueous (water based), non-aqueous and solid state. The choice of electrolyte is often dictated by the battery chemistry of the anode/cathode pair. Many battery chemistries such as carbon zinc and alkaline batteries use aqueous electrolyte while lithium batteries require a non aqueous or solid state electrolyte.

The choice of electrolyte often determines the suitability of a given battery for a given application. This is especially true if the battery will be used or processed at high temperatures. Aqueous electrolytes which contain water cannot be used when the processing or use conditions allow the battery to exceed 100 C, which is the boiling point of water. Similarly, lithium ion electrolytes often contain low boiling solvents which prevent their use when processing or operating temperatures exceed the boiling point of the electrolyte.

This limitation has been overcome through the development of polymer based and solid state electrolytes for lithium based batteries. However, lithium based batteries are relatively expensive which has limited their utility to applications which can tolerate expensive batteries. On the other hand, the lowest cost battery chemistry is carbon zinc but the use of aqueous electrolyte has prevented their use at high temperature based on the electrolyte composition. There is a need for combining the low cost of carbon zinc battery materials with the high temperature capability of some non-aqueous lithium battery electrolytes.

In addition to high temperature processing and use, many embedded power sources impact the overall appearance of the finished product. In the case of credit card manufacturing, it is highly desirable to create a flat battery structure which varies in thickness across the battery structure as little as possible. This requirement is based on the need for a credit card to have a smooth surface free of defects such as depressions or other obvious defects which are very visible on the surface of a glossy credit card and unacceptable to meet market requirements. Batteries with an uneven surface or a variation in thickness across the battery often requires significant effort and cost during the card making process to embed the battery as the differences in thickness or surface contour requires addition of a glue or resin or the build-up of a complex three dimensional structure to account for battery variations.

Batteries of the prior art typically use a so called pillow design to seal the batteries, in this design, the seal is obtained by heat sealing the perimeter and allowing the battery packaging to conform to body of the battery. This results in a battery topography which is highly variable across the individual battery as well as from battery to battery. High volume manufacturing of products, such as credit cards, would benefit tremendously if the topography of the batteries were of constant height and consistent across high volumes of individual cells.

Thin batteries require a seal to prevent loss of electrolyte, provide mechanical integrity and to contain all liquid components within the cell. Batteries produced via the prior art have focused on adhesive system such as lamination adhesives, heat seals and the like. Seal integrity is especially critical in the battery tabs area where the electrical connectors are brought from the interior of the battery through the seal to the external connector area. It would be highly advantageous if the seal area would perform both the required mechanical and seal properties of the cell as well as provide dimensional stability to the overall structure of the battery.

Additional desired features include the ability to form the battery into a variety of shapes and sizes to fit the battery into the desired product. Ideally, the ability to customize the battery to a unique shape or size is accomplished at low cost and would not require an extensive level of unique tooling or other process changes which would make the battery cost prohibitive.

For example, a credit card application may require a square battery to fit into the existing space to provide power to other components embedded into the card. In the case of a battery powered pregnancy tester, it is highly desirable to form the battery as a narrow rectangle. In the case of a powered RFID tag, it would be desirable to produce a round battery to fit within the antenna coil. Clearly, a battery which could be easily customized at low cost is highly desirable.

Likewise, many applications require the battery to survive bending or forming around a radius. In this case, the construction of the cell should minimize the potential for electrical shorting or mechanical failures. In certain flat battery design of the prior art, the electrodes face each other separated by the electrolyte/separator structure of the cell. It has been found that electrical shorts can develop over time when the battery is subjected to repeated stresses such as bending or torsions applied to the battery. This occurs when a fissure develops with the material separating the two opposing electrodes which results in electrical contact of the opposing electrodes resulting in catastrophic failure of the battery.

Many applications are very volume, which require the lowest possible cost. In many cases, the applications are disposable in the form of a label, tag, greeting card, credit card and the like. In order to enable product introductions the battery costs will need to be as low as possible. In addition, the battery chemistry used should have minimal environmental impact and pose low human health and safety concerns.

In many applications, the battery is used to power microprocessors or other electrical components. Many of the desired components operate at three volts Direct Current (3 VDC). Therefore, a battery technology which could be customized to provide 3 VDC is often a product requirement. However, many applications require a battery providing 1.5 VDC or other specialized voltages depending on the intended application. In order to meet broad market needs, a battery which could provide a range of output voltages, be easily customized, maintain a uniform geometry, provide low cost and tolerate high processing temperature and pressures would address many of the deficiencies which currently exist in the art.

The present subject matter addresses many of the deficiencies of the prior art. In various embodiments, the present subject matter provides, among other things, a low cost carbon zinc battery chemist which can be processed and used at high temperatures. In various embodiments, the present subject matter provides among other things a printed battery housed in a rigid packaging system which provides a planar surface with consistent thickness across the individual battery as well as from battery to battery and batch to batch in very high volumes at low cost. In various embodiments, the present subject matter provides, among other things, an all printed battery. In various embodiments, the present subject matter provides, among other things, an all printed battery housed in a novel rigid packaging system which provides a planar surface with consistent thickness across the individual battery as well as from battery to battery and batch to batch in very high volumes at low cost. Other benefits and aspects in combination and in variation are provided, by the present subject matter.

### SUMMARY

Batteries consist of an anode, cathode, electrolyte and a means to electrically connect the battery to the device powered by the battery. In addition, the battery is housed in a packaging system to contain the battery chemistry and prevent leaking. The packaging system along with the deposition of the battery components employed determines the shape and the thickness of the battery.

An aspect of some embodiments of the present subject matter is to provide a non-aqueous electrolyte for carbon zinc batteries which allows high temperature processing or use.

An aspect of some embodiments of the present subject matter is to provide a rigid packaging system which maintains uniform thickness across the entire battery structure.

An aspect of some embodiments of the present subject matter is to provide an embedded conductive bus system which is contained within the rigid packaging seal,

An aspect of some embodiments of the present subject matter is to provide a process which reproducibly produces batteries at the desired thickness at very high production rates.

An aspect of some embodiments of the present subject matter is a battery which is produced entirely by the printing process.

An aspect of some embodiments of the present subject matter is to provide batteries with nominal voltages in multiples of 1.5 VDC by utilizing combinations of various aspects of the present subject matter.

This Summary is an overview of some of the teachings of the present application and is not intended to be an exclusive or exhaustive treatment of the present subject matter. Further details about the present subject matter are found in the detailed description. The scope of the present invention is defined by the appended claims and their equivalents.

### BRIEF DESCRIPTION OF THE DRAWINGS

FIG. 1 illustrates a 3V battery, according to one embodiment of the present subject matter.

FIG. 2 illustrates a cross sectional view of the battery of FIG. 1, according to an embodiment of the present subject matter.

FIG. 3A illustrates a surface profile of a battery, according to one embodiment of the present subject matter.

FIG. 3B illustrates a prior art “pillow seal” type battery profile.

FIGS. 4A-4C illustrate multiple cell batteries, according to various embodiments of the present subject matter.

FIGS. 5A-5B illustrate a sheet: of individual printed batteries, according to various embodiments of the present subject matter.

### DETAILED DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

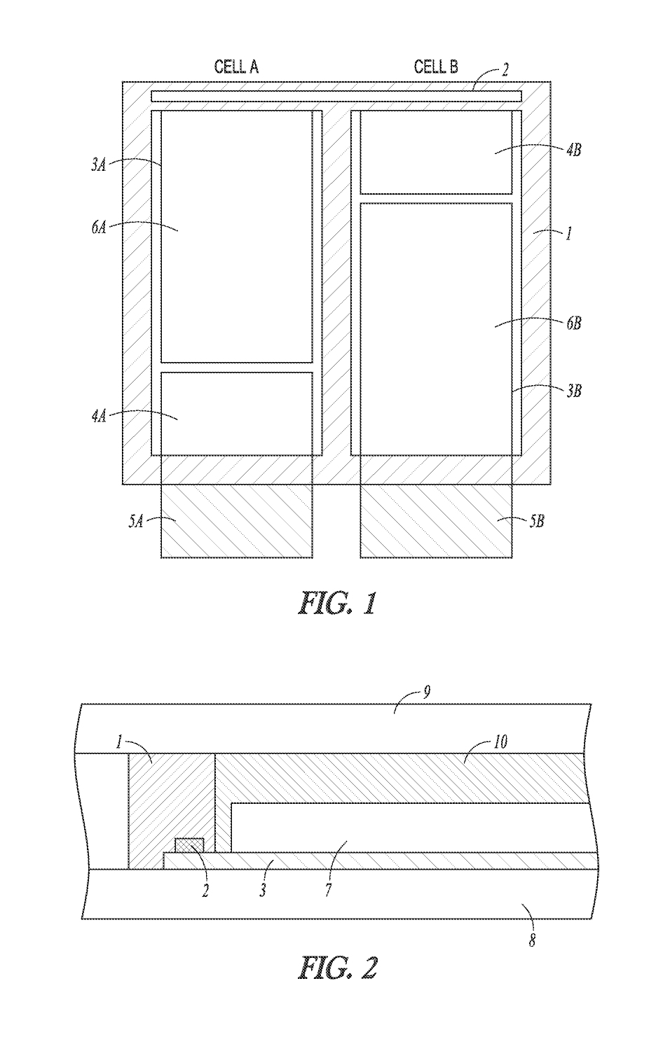

The battery of the present subject matter consists of several elements. FIG. 1 illustrates elements of the 3V battery of the present subject matter, according to an embodiment. The battery consists of two 1.5V cells identified as cell A and cell B in FIG. 1. The various elements include the following which will be described in greater detail below: Cathode current collector 3A and 3B, cathode 6A and 613, anode 4A and 4B, conductive bus bar 2, electrolyte, heatseal 1 and conductive hot-melt adhesive 5A and 5B which form the battery connectors. FIG. 2 illustrates the cross section view of this battery embodiment to further illustrate construction of the battery. In this view the lower substrate 8 has been printed with the cathode current collector 3, the cathode 7, the anode (not shown), silver bus bar 2 which is electrically connected to the cathode current collector 3. The electrolyte 10 is printed over the entire area of the anode and cathode for both Cell A and Cell B. The rigid seal 1 is printed on the top substrate 9 which is laminated to the bottom structure.

According to various embodiments, the present subject matter utilizes a non-aqueous electrolyte in place of water based electrolytes used in the prior art. For purposes of illustration, a carbon zinc battery will be described, although those skilled in the art will recognize that other battery chemistries based on aqueous electrolytes can be substituted within the scope of the present subject matter. The battery production process is based on the printing process in which all elements are converted into printable inks which can be processed using conventional methods and equipment.

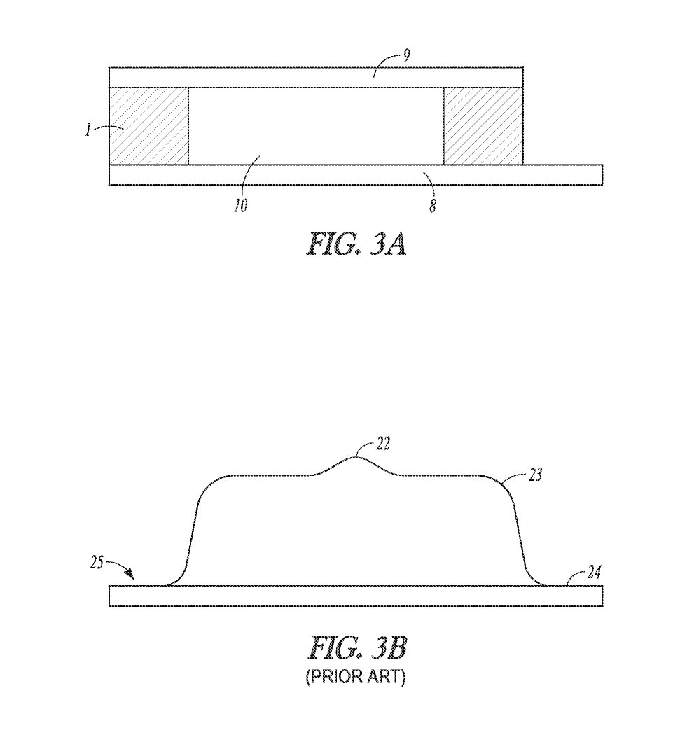

An important result of the battery of the present subject matter is a very uniform surface profile as illustrated in the embodiment of FIG. 3A. The top film 9 and bottom film 8 are fixed with the rigid seal 1 to form a uniform profile across the battery surface. The battery components including the cathode, anode and electrolyte are housed in the cell 10 created by the structure. As described below, the printing process controls the thickness of each printed, layer to insure the thickness of the battery components does not exceed that of the printed rigid seal 1. This allows the rigid seal to melt and flow during the lamination process to set a consistent thickness and uniform surface profile and completely square edges.

This is contrasted with certain prior art designs which use a so called “pillow seal,” as shown in FIG. 3B. In such designs, the seal 24 and 25 is formed by compressing the edge of the battery around the battery components such as the anode, cathode and electrolyte. The result is curved edge 23 and non-uniform surface 22 as the packaging film conforms to all of the various battery components. This deficiency in this approach is important in applications requiring embedding of the battery in products such as a credit card where the battery shape will impact the surface and must be corrected using very costly measures.

Geometry

The printing process affords significant flexibility in configuring the battery geometry. The configurations provided by the present subject matter, are co-facial and opposing electrodes, in various embodiments. In co-facial designs, the anode and cathode are printed on the same substrate for all cells and subsequently covered with printed electrolyte in each cell. In opposing electrode configurations, the anode and cathode are printed on opposite surfaces and then laminated together with anode and cathode facing each other with electrolyte sandwiched between the electrodes. The shape, size and thickness of all ink layers can be customized to fit specific battery requirements such as battery area, thickness, voltage and capacity.

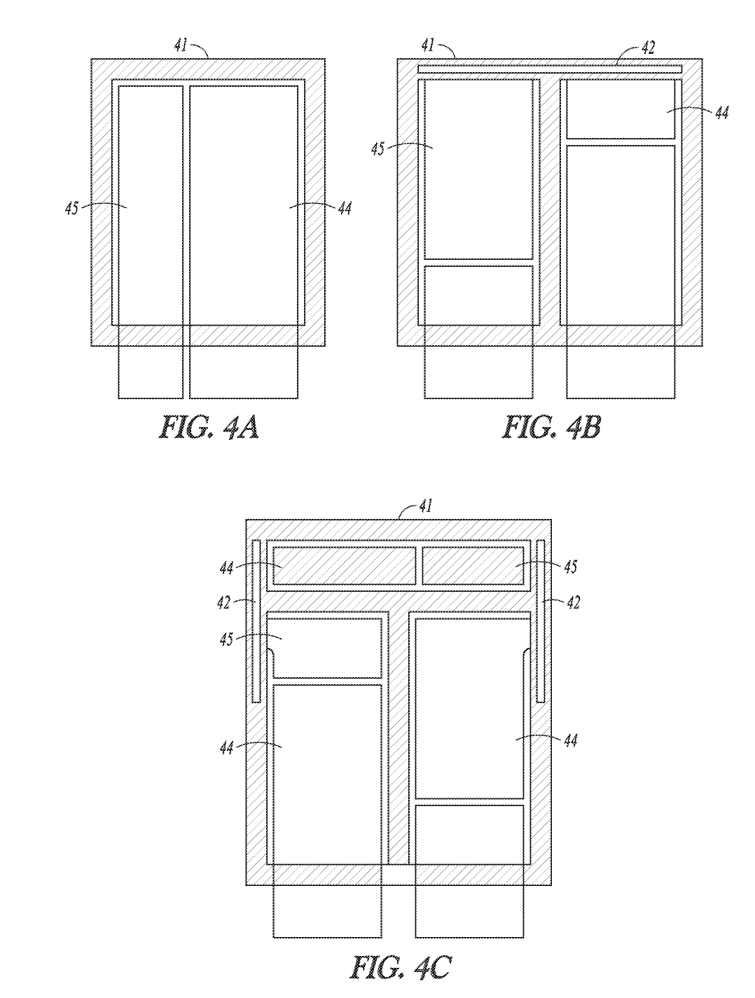

In the case of carbon zinc battery chemistry, the nominal voltage per electrochemical cell is 1.5V. If higher voltages are required, the battery will consist of multiple cells, printed in series, to obtain the desired voltage at the tabs in various embodiments. The individual cells are electrically connected through a printed conductive bus bar contained within the battery seal area. FIGS. 4A-4C illustrate this concept for three batteries at different voltages. To obtain a 1.5 volt battery as shown in FIG. 4A, the anode 45 is printed adjacent to the cathode 44. The rigid seal 41 is printed around the perimeter of the cell to mechanically seal the battery and fix the geometry. The 3 volt (FIG. 4B) and 4.5 volt (FIG. 4C) batteries are formed by printing multiple cells in series and connecting the cells together with a conductive bus bar 42 protected in the rigid seal 41. In the case of multiple cells, the rigid seal 41 also serves an important role by electrically insulating the various adjacent cells to prevent shorting the cells together which would discharge the various cells. The 3 volt battery contains two anodes 45 and two cathodes 44 while the 4.5 volt battery contains three anodes 45 and three cathodes 44. The anodes and cathodes are arranged in each cell to allow the electrical connection through the printed bus bar 42 embedded in the rigid seal 41.

Due to the inherent flexibility of the printing process, the choice of co-facial or opposing electrode configuration can be determined by the application. In cases where the ultimate goal is durability, especially when significant flexing is required, would select the co-facial as the potential for electrode shorting is greatly diminished. On the other hand, if the available area for the battery is limited, the opposing electrode configuration is preferred as the area required is reduced.

Cathode Current Collector

Traditional cathode materials based on Manganese Dioxide are not conductive enough to provide adequate current flow which results in high internal resistance in the battery. Therefore, it is desirable to print a conductive material below the printed cathode to provide a current path. Additionally, the cathode current collector should not be active electrochemically which would interfere with the battery performance as well as cause corrosion which dramatically reduces battery life.

Conductive carbon inks meet these requirements as they provide adequate conductivity but do not participate in the battery electrochemistry. Several conductive carbons are suitable such as ECM Part number CI-2001, Spraylat Part number XCMC-040 and Creative Materials Part number EXP 2620-33B, in various embodiments. Those skilled in the art will recognize that other suitable carbons exist and the present subject matter is not limited to specific carbon inks.

The cathode current collector serves additional functions in battery. In addition to acting as a current collector, the conductive carbon also forms the positive terminal for the battery and in cases where multiple batteries are printed in series, to form the contact point for the conductive bus bar.

It is desirable to print the conductive carbon as thin as possible to minimize the overall thickness of the battery. According to one embodiment, the preferred thickness of the conductive carbon is between 8 and 20 microns, preferably between 8 and 12 microns in the dried form.

Anode

In the case of Carbon zinc batteries, the active anode material is zinc metal. However, zinc powders are not suitably conductive to form a printable ink with sufficient conductivity. However, this shortcoming is overcome by formulating an ink which contains other conductive metals such as silver or copper in addition to the required zinc, in various embodiments. By using a combination of metals in the anode, sufficient conductivity is achieved in the printed anode layer.

In the case of zinc/silver inks, sufficient conductivity is achieved by adding 5-15% silver flake by weight to the ink. Typical zinc concentrations vary from 30-50% zinc powder by weight. The balance of the ink formulation consists of binders, solvent and other additives which improve the printability of ink.

In addition to forming the battery anode, the anode ink layer also performs other important functions in the battery. This printed ink layer forms the negative terminal in the battery and can be printed, with tabs if multiple batteries in series are required. Additionally, it is also possible to form the bus bar using this ink as long as sufficient conductivity is achieved with this dried ink film.

According to various embodiments, the anode inks are printed, with a thickness of 30-75 microns and the preferred thickness of 40-60 microns of the dried ink film. The thickness of the anode ink layer is determined by the desired capacity of the battery which is determined by the zinc concentration in combination with the required conductivity of the ink layer which is influenced by both the silver concentration and overall ink thickness. In various embodiments, other thicknesses may be used without departing from the scope of the present subject matter.

Examples of suitable ink compositions include Spraylat Part number XZNBI-406 and Creative Materials Part number EXP 2620-34. Those skilled in the art will recognize that other suitable anode inks exist and the present subject matter is not limited to specific inks.

Bus Bar

The electrochemical potential of various battery couples is well known in the art. When battery voltages are required which exceed the nominal potential of the battery electrochemistry, multiple batteries can be printed and connected electrically in series. For example carbon zinc electrochemistry has a potential of 1.5 VDC per cell, while lithium electrochemistry has a potential of 3.0 VDC. If the desired battery voltage is 6 VDC at the terminals, it is possible to either connect 4 carbon zinc cells or two lithium cells in series.

The present subject matter accomplishes this by printing a conductive bus bar within the seal of the battery. According to various embodiments, the bus bar consists of conductive inks such as conductive silver, conductive carbon or the anode ink itself. The bus bar is printed in the battery seal area to insulate it from the battery cells which prevents electrical shorting and corrosion, in various embodiments,

The bus bar uses conductive silver which provides the lowest resistance and the thinnest ink film thickness. The ink film thickness is controlled to prevent compromising the seal integrity. Suitable conductive silvers include, but are not limited to, Spraylat Part number XCSD-006N and ECM Part number CI-1028.

The thickness of the dried ink layer is between 2 and 8 microns, in various embodiments. The preferred thickness is between 3 and 6 microns which will provide low internal resistance to the battery with acceptable ink heights which will not compromise the seal integrity.

Cathode

In the case of carbon zinc batteries, the active cathode material consists of manganese dioxide. However, manganese dioxide is not conductive and is blended with conductive graphite to achieve sufficient conductivity to allow electron flow through the cathode layer.

The cathode is printed over the carbon current collector within the seal area. According to various embodiments, the thickness of the cathode layer is between 60 and 140 microns with the preferred thickness of the dried cathode area between 90 and 110 microns.

One suitable cathode ink is Spraylat Part Number XCBI-378. Those skilled in the art will recognize that other suitable cathode inks exist and the present subject matter is not limited to specific inks.

Battery Seal

In order to achieve the desired uniform thickness across the battery surface, a seal is used which will flow. One such material is a printable heat seal which flows upon reaching the melt point of the material. The seal performs several functions in addition to setting the overall thickness of the battery. The first function is that the seal around the perimeter provide mechanical integrity to the battery itself and prevents any leakage from the cell. Secondly, if multiple cells are used in series, the seal material prevents any leakage between the cells as well as electrically insulates the cells to prevent electrical shorting between the cells.

According to an embodiment, the seal is applied in two layers by printing the seal on the battery layer and printing it on the cover film layer. Typically, the layer printed on the battery layer is between 25 and 50 microns. This layer is printed to allow the seal material to flow over the tab areas and to flow around the bus bar configuration. The second layer is printed on the top film which subsequently determines the overall thickness of the battery, in an embodiment.

The seal thickness for the second layer is determined by calculating the overall thickness of the printed battery components which includes the heights of the various battery layers. The seal material on the battery layer then functions as a buffer layer which will flow upon setting the overall height of the battery to the desired thickness.

The seal material includes the following attributes: rigidity upon sealing, flow under specified conditions, non-reactive to the battery chemistry and printable in the desired thickness. One suitable seal material is a printable heat seal Part number DI-7010 available from ECM. Other suitable seals are known in the art.

The printed thickness of the seal is adjusted based on the thickness of the other printed battery inks. According to various embodiments, the seal is printed 25-50 microns thicker to allow for flow to set the height of battery to the desired thickness. This seal thickness can be calculated using the following formulas:

Co-facial Battery design: Cathode Current Collector (microns)+Cathode (microns)+Electrolyte (microns)+buffer (25-50) microns Opposing Electrode Battery design: Current Collector (microns)+Cathode (microns)+Anode (microns)+Electrolyte (microns)+buffer (25-50 microns)

These formulas are intended to demonstrate some embodiments of the present subject matter and are not intended to be exclusive or exhaustive. Other variations exist within the scope of the present subject matter.

Electrolyte

Electrolytes which can be printable include the particular salts required to affect the appropriate electrochemistry. In the case of prior art carbon zinc batteries, the electrolyte is a solution of salts such as zinc chloride and/or ammonium chloride in water. The electrolytes of the present subject matter are based on solutions of salts in a non-aqueous solvent such as propylene carbonate, di-ethylene glycol and other aprotic polar organic solvents, in various embodiments.

In various embodiments, the electrolyte solvents of the present subject matter include the following qualities:
1. Boiling points greater than 100 C preferably greater than 150 C;
2. Solubility of zinc chloride and/or ammonium chloride of greater than 15% by weight, preferably greater than 20% by weight and most preferably greater than 25% by weight;
3. Using gelling agents such as cross-linked polymer matrixes such as cross-linked starch, polyacrylic acid, polyacrylamid or other gelling agents known in the art.

In various embodiments, the desired print thickness of the electrolyte is between 60 and 150 microns, preferably between 90 and 110 microns thick.

Other qualities and dimensions are possible without departing from the scope of the present subject matter.

Terminals

The all printed batteries of the present subject matter are printed on plastic substrates which use adhesives to attach the battery to the desired device to be powered. Most often this is in the form of a printed circuit board or other such device. Soldering, thermal compression bonding or other conventional attachment techniques may not work with such substrates.

The batteries of the present subject matter use a conductive hot melt adhesive which is printed in the tab area, according to an embodiment. This allows a simple heat stake to attach the battery to the device. One such adhesive is Creative Materials Part number CMI-124-33. The adhesive is printed and dried using conventional drying techniques which results in a tack free surface. According to various embodiments, the thickness of the printed adhesive is 30 -70 microns with the preferred thickness of 40-50 microns.

Substrates

A wide range of substrates can be used in the present subject matter. These include polyesters, nylons, PETG, polycarbonates and the like. Additionally, barrier film laminates can be used to provide barrier properties such as moisture or solvent transmission. In the case of carbon zinc batteries, the electrolytes will contain water so it is desirable to prevent loss of water through the films.

Foil laminates provide the highest level of moisture barrier, although other barrier films will perform as well. However, the foil will be conductive, so it should be insulated, by laminating plastic films to the front and back of the foil. One such laminate is Part number 5367-G available from Curwood Inc.

The thickness of the substrate is largely determined by the equipment used to produce the battery. As it is often desirable to produce the thinnest possible battery, substrates are usually chosen to be as thin as possible for the printing process used. In the case of sheet fed printing processes, substrates are chosen which are between 50 and 300 microns, preferably between 75 and 125 microns. Web printing processes can usually handle thinner film; therefore the thickness of the substrates can be thinner, preferably between 25 and 100 microns.

Battery Sheets

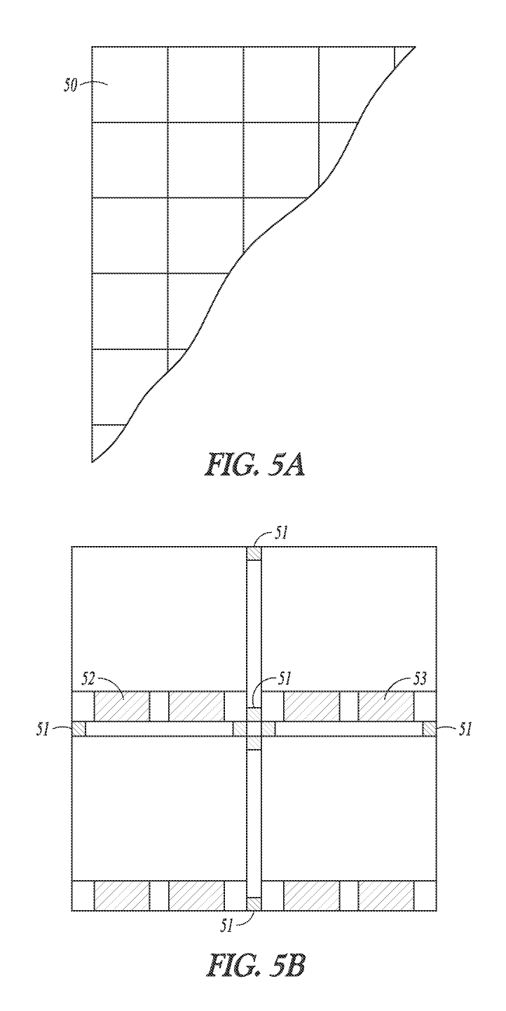

The all printed nature of the batteries allows the batteries to be sold in sheets of batteries which are then singulated at the time of use. The sheets are formed through a die cutting process which leaves small ties between each battery, according to various embodiments. The strength of the ties can be adjusted by increasing or decreasing the number or size of ties. This approach has several significant advantages including ease of handling, testing and shipment. Handling single batteries creates significant handling and packaging costs whereas handling, for example, a sheet of 100 batteries greatly simplifies the handling and packaging cost associated with the batteries. FIG. 5A illustrates a sheet of individual batteries 50. The sheet of batteries is formed by leaving ties 51 in each corner of individual batteries (as shown in FIG. 5B), in an embodiment. Testing of the batteries is greatly simplified as the positive tab 52 and the negative tab 53 are in the identical location which allows testing fixtures to test entire sheets of batteries.

The methods illustrated in this disclosure are not intended to be exclusive of other methods within the scope of the present subject matter.

The above detailed description is intended to be illustrative, and not restrictive. The scope of the invention should, therefore, be determined with reference to the appended claims along with the full scope of equivalents to which such claims are entitled.

1. An all printed carbon and zinc battery, comprising:
a lower substrate;
a cathode current collector printed on the lower substrate;
a cathode printed on the cathode current collector;
an anode printed on the lower substrate adjacent the cathode;
a non-aqueous electrolyte printed over the anode and the cathode; and
atop substrate laminated to the electrolyte.

2. The battery of claim 1, further comprising a seal printed on the top substrate, wherein the seal is printed with a thickness such that a combined thickness of the cathode current collector, the cathode, the anode and the non-aqueous electrolyte does not exceed the thickness of the seal, such that the seal melts and flows during lamination of the top substrate to provide a uniform surface profile of the battery.

3. The battery of claim 2, further comprising a conductive bus bar contained within the seal, the conductive bus bar electrically connected to the cathode current collector and adapted to connect multiple battery cells.

4. The battery of claim 1, further comprising a conductive hot-melt adhesive connected to the anode and the cathode to form battery connectors.

5. The battery of claim 1, wherein the all printed battery includes a rigid planar surface with substantially consistent thickness across the battery.
